(19) United States
(12) Patent Application Publication
(10) Pub. No.: US 2006/0169565 A1
(43) Pub. Date: Aug. 3, 2006

(54) Multi-plate type friction engaging apparatus and bush for such multi-plate type friction engaging apparatus

(76) Inventor: Kiyokazu Ichikawa, Fukuroi-shi (JP)

Correspondence Address: MILES & STOCKBRIDGE PC, 1751 PINNACLE DRIVE, SUITE 500, MCLEAN, VA, 22102-3833, US

(21) Appl. No.: 11/335,495

(22) Filed: Jan. 20, 2006

(30) Foreign Application Priority Data
Jan. 21, 2005 (JP) 2005-014423

(51) Int. Cl. F16D 25/0638

(52) U.S. Cl. 192/85 AA; 192/110 B

(57) ABSTRACT

The present invention provides a multi-plate type friction engaging apparatus for transmitting a power by engagement of a plurality of plural friction elements housed in a housing, which comprises a hub provided on an inner periphery of the housing and a bush interposed between the hub and a shaft on which the hub is slid, and wherein a groove extending in an axial direction is formed in an outer peripheral surface of the bush.

### BACKGROUND OF THE INVENTION

1. Field of the Invention

The present invention relates to a multi-plate type friction engaging apparatus used in an automatic transmission of a vehicle and the like, and more particularly, it relates to a bush used in such a multi-plate type friction engaging apparatus.

2. Related Background Art

In general, in a friction engaging apparatus used in an automatic transmission, a housing or drum having a clutch portion is supported rotatably with respect to an inner race or a shaft. A bush as a bearing is interposed between the drum and the shaft.

Such a friction engaging apparatus is disclosed in Japanese Patent Application Laid-open No. 8-261247 (1996) in which a bush is provided between a housing or power transmitting drum and an inner race.

In recent years, due to the fact that a high speed and compactness of a vehicle have been realized and the number of stages of the automatic transmission has been increased, a high speed rotation of a rotary member of a clutch used in the automatic transmission is requested. Thus, an amount of heat generated in a bearing for supporting the friction engaging apparatus is increased, with the result that there arises a problem regarding seizure of the bush.

### SUMMARY OF THE INVENTION

Thus, an object of the present invention is to provide a multi-plate type friction engaging apparatus and a bush used in such a multi-plate type friction engaging apparatus, which can reduce an amount of heat generated in sliding areas of the bush and seizure of the bush.

To achieve the above object, the present invention provides a multi-plate type friction engaging apparatus in which a power is transmitted by engagement of plural friction elements housed in a housing and wherein it comprises a hub provided on an inner periphery of the housing and a bush interposed between the hub and a shaft on which the hub is slid, and a groove extending in an axial direction is formed in an outer peripheral surface of the bush.

Further, to achieve the above object, the present invention also provides a bush which is used in a multi-plate type friction engaging apparatus for transmitting a power by engagement of a plurality of friction elements housed in a housing and which is interposed between a hub provided on an inner periphery of the housing and a shaft on which the hub is slid and wherein a groove extending in an axial direction is formed in an outer peripheral surface or outer and inner peripheral surfaces of the bush.

Since the groove(s) are formed in the outer peripheral surface or the outer and inner peripheral surfaces of the bush, lubricating oil supplied from the shaft passes through the groove(s) and absorbs heat from the outer diameter portion of the bush, thereby preventing or reducing seizure in sliding areas.

Further, since the groove extending in the axial direction is formed in the outer peripheral surface of the bush, the lubricating oil which was supplied from the shaft and which cooled the outer diameter portion of the bush is supplied to a clutch side of the friction engaging apparatus efficiently, with the result that a smooth operation of the friction engaging apparatus can be obtained and the endurance to the seizure can be extended.

### BRIEF DESCRIPTION OF THE DRAWINGS

FIG. 1 is an axial partial sectional view of a multi-plate type friction engaging apparatus according to the present invention;

FIG. 2 is an axial partial sectional view showing a bush and its neighborhood of a bush of FIG. 1 in an enlarged scale;

FIG. 3 is a partial perspective view showing an example of a groove formed in an outer peripheral surface of the bush;

FIG. 4 is a partial perspective view showing an example of a groove formed in an outer peripheral surface of the bush and having a predetermined angle with respect to an axial direction;

FIG. 5 is a partial perspective view for explaining an example of grooves formed in outer and inner peripheral surfaces of the bush; and

FIG. 6 is a partial perspective view showing an example of a helical groove formed in an outer peripheral surface of the bush.

### DESCRIPTION OF THE PREFERRED EMBODIMENTS

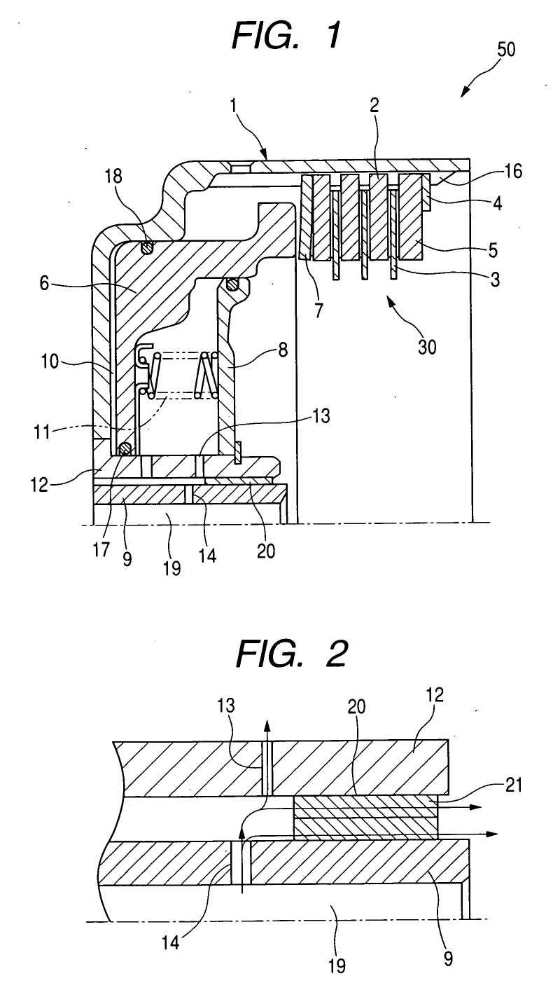

FIG. 1 is an axial partial sectional view of a multi-plate type friction engaging apparatus according to the present invention, and FIG. 2 is an axial partial sectional view showing a bush and its neighborhood of a bush of FIG. 1 in an enlarged scale. A multi-plate type friction engaging apparatus 50 shown in FIG. 1 a substantially cylindrical clutch case or housing 1 having one end opened in an axial direction, separator plates 2 as friction elements capable of being shifted along the axial direction in splines 16 formed in an inner periphery of the housing 1, and friction plates 3 as friction elements disposed in splines formed in an outer periphery of a hub (not shown) which can be rotated on a common shaft and to which friction materials are fixed. The separator plates 2 and the friction plates 3 are arranged alternately along the axial direction.

Further, the multi-plate type friction engaging apparatus 50 includes a piston 6 which serves to urge and firmly connect the separator plates 2 and the friction plates 3 (which constitute a clutch portion 30) in the axial direction, and a stop ring 4 provided on the inner periphery of the housing 1 to hold axial one ends (corresponding to the open end of the housing 1) of the separator plates 2 and the friction plates 3 via a packing plate 5 in a fixed condition.

A coned disc spring 7 for providing pre-pressure is interposed between the separator plate 2 nearest to a closed end of the housing 1 and the piston 6. That is to say, the piston 6 serves to tighten the clutch portion 30 via the coned disc spring 7.

As shown in FIG. 1, the piston 6 is axially slidably received within the closed end of the housing 1. Further, an O-ring 17 is interposed between the piston 6 and a hub 12. In addition, an O-ring 18 is interposed between the piston 6 and the housing 1. A hydraulic chamber 10 is defined between an inner surface of the closed end of the housing 1 and the piston 6. The hydraulic chamber 10 is maintained in an oil-tight condition by means of the above-mentioned two O-rings 17 and 18. Here, while the housing 1 and the hub 12 are formed separately, these members may be formed integrally.

Predetermined pressurized oil is supplied to the hydraulic chamber 10 via an oil path (not shown) from an oil supply path 19 formed within a shaft or output shaft 9 and connected to a pressurized oil source (not shown), thereby shifting the piston 6 in the axial direction in order to tighten the clutch portion 30. When the oil pressure in the hydraulic chamber 10 is released, the piston 6 is returned to its original position by a biasing force of a return spring 11 disposed between a canceller 8 and the piston 6, thereby releasing the tightening of the clutch portion 30.

In the multi-plate type friction engaging apparatus 50 so constructed, the clutch is engaged and disengaged as follows. FIG. 1 shows a disengaged condition of the clutch. In this condition, the separator plates 2 are separated from the friction plates 3 or are slightly contacted with the friction plates. In the disengaged condition, the piston 6 is positioned at the closed end of the housing 1 by the biasing force of the return spring 11.

From this condition, in order to engage the clutch, the pressurized oil is supplied to the hydraulic chamber defined between the piston 6 and the housing 1. As a result, by the oil pressure, the piston 6 is shifted to the right along the axial direction in opposition to the biasing force of the return spring 11 to closely contact the separator plates 2 with the friction plates 3. In this way, the clutch is engaged.

In order to disengage the clutch, the pressurized oil is removed from the hydraulic chamber 10. When the pressurized oil is removed, the piston 6 is shifted by the biasing force of the return spring 11 until the piston 6 abuts against the closed end of the housing 1. In this way, the clutch is disengaged.

Next, a bush 20 used in the multi-plate type friction engaging apparatus 50 according to the present invention will be fully explained with reference to FIG. 2. A groove 21 extending in the axial direction is formed in an outer peripheral surface of the bush 20. The groove 21 constitutes a passage or path for lubricating oil. That is to say, the lubricating oil flowing out of the oil supply path 19 of the output shaft through an oil port 14 flows along two paths, as shown by the arrows in FIG. 2. An oil flow shown by the arrow A flows through an oil port 13 formed in the hub 12 and enters into the interior of the multi-plate type friction engaging apparatus 50. Then, after the lubricating oil is filled within the canceller chamber, the oil lubricates sliding surfaces between the piston 6 and the hub 12 and between the canceller 8 and the piston 6.

On the other hand, the oil flow B shown by the arrow B passes through the groove 21 of the bush 20 and is directed toward the clutch portion 30 to lubricate the clutch portion 30. Further, the lubricating oil is also directed toward a space between the bush 20 and the output shaft 9 to lubricate an interface therebetween. The groove 21 and grooves 22 to 25 (described later) also serves as paths for lubricating oil lubricating other parts.

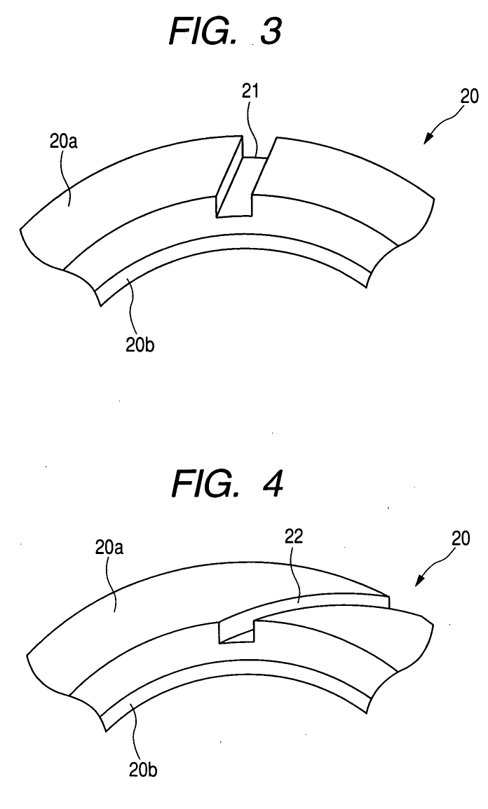

FIGS. 3 to 6 are partial perspective views for explaining examples of groove(s) formed in the outer peripheral surface or inner and outer peripheral surfaces of the bush 20. FIG. 3 shows the bush 20 shown in FIGS. 1 and 2, where the groove 21 extending in the axial direction is formed in the outer peripheral surface 20a of the bush. No groove is formed in an inner peripheral surface 20b of the bush. The groove 21 has a depth substantially corresponding to a half of a radial back plate thickness of the bush 26. Although not shown, plural grooves 21 are provided equidistantly along a circumferential direction.

FIG. 4 is a partial perspective view showing an example of a groove 22 formed in the outer peripheral surface of the bush and having a predetermined angle with respect to the axial direction. The groove 22 extends in the axial direction; however, different from the groove 21 shown in FIG. 3, the groove 22 has the predetermined angle with respect to the axial direction.

Similar to the example shown in FIG. 3, no groove is formed in the inner peripheral surface 20b of the bush. Further, the groove 22 has a depth substantially corresponding to a half of a radial back plate thickness of the bush 20. Although not shown, plural grooves 22 are provided equidistantly along the circumferential direction. By forming the grooves 22 obliquely, during an operation of the multi-plate type friction engaging apparatus 50, i.e. during the rotation, the lubricating oil can be supplied to the required areas efficiently. Further, since the lubricated areas are increased, lubricating performance and cooling performance for the sliding parts are enhanced, thereby suppress generation of heat effectively and reducing the seizure.

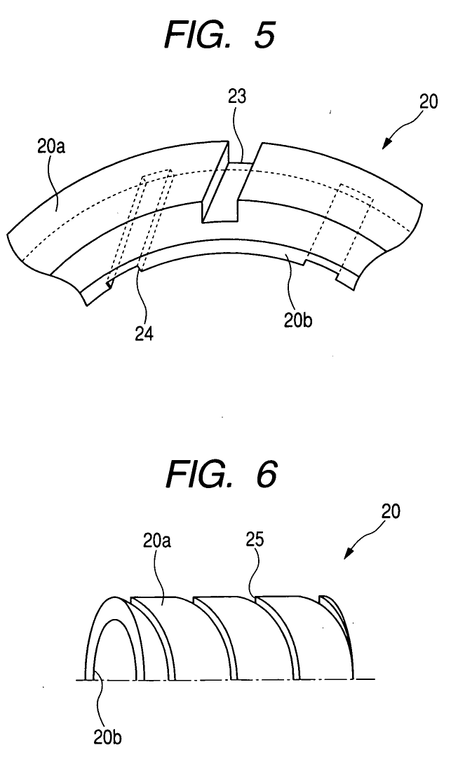

FIG. 5 is a partial perspective view for explaining an example of grooves formed in the outer peripheral surface or inner and outer peripheral surfaces of the bush. In this example, a groove 23 substantially similar to the groove 21 of FIG. 3 is formed in the outer peripheral surface 20a of the bush 20 and grooves 2-4 are also formed in the inner peripheral surface 20b of the bush 20. The groove 24 is similar to the groove 23.

As can be seen from FIG. 5, plural grooves 23 formed in the outer peripheral surfaces 20a and plural grooves 24 formed in the inner peripheral surface 20b are provided along the circumferential direction, and the grooves 23 and 24 are staggered with each other. Each of the grooves 23 has a width substantially corresponding to a half of a radial back plate thickness of the bush 20 and each of the grooves 24 has a thickness substantially corresponding to a half of a lining portion (alloy portion) of the bush.

FIG. 6 is a partial perspective view showing an example of a helical groove formed in the outer peripheral surface of the bush. In this case, the helical groove 25 is formed in the outer peripheral surface 20a of the bush 20. The groove 25 is formed as a single groove extending continuously from an axial one end of the bush 20 to the other end of the bush. By providing the helical groove 25, since the lubricated areas are further increased in comparison with the examples of FIGS. 3 to 5, the lubricating performance in the sliding parts is further enhanced. Further, the cooling performance is also enhanced, thereby suppressing generation of heat in the sliding parts effectively and reducing the seizure.

In the above-mentioned multi-plate type friction engaging apparatus, although the plural grooves are formed in the bush along the circumferential direction, the number of the grooves may be selected voluntarily, and a single groove may be used. Further, the grooves can be formed in the outer peripheral surface or inner and outer surfaces of the bush, and all of the grooves can be formed in only the outer peripheral surface or formed in both inner and outer surfaces, or grooves having different shapes can be combined. Further, it should be noted that the circumferential width and depth of the groove can be selected voluntarily. In addition, the grooves can be formed by press working or cutting working.

This application claims priority from Japanese Patent Application No. 2005-014423 filed on Jan. 21, 2005, which is hereby incorporated by reference herein.

What is claimed is:

1. A multi-plate type friction engaging apparatus for transmitting a power by engagement of a plurality of plural friction elements housed in a housing, comprising:
a hub provided on an inner periphery of said housing and a bush interposed between said hub and a shaft on which said hub is slid,
and wherein
a groove extending in an axial direction is formed in an outer peripheral surface of said bush.

2. A multi-plate type friction engaging apparatus according to claim 1, wherein a groove extending in the axial direction is formed in an inner peripheral surface of said bush.

3. A multi-plate type friction engaging apparatus according to claim 1, wherein said groove is cooled by lubricating oil.

4. A multi-plate type friction engaging apparatus according to claim 1, wherein a plurality of said grooves are provided in parallel with each other in an axial direction.

5. A multi-plate type friction engaging apparatus according to claim 1, wherein said groove is a helical groove.

6. A multi-plate type friction engaging apparatus according to claim 1, wherein said groove has a predetermined angle with respect to the axial direction.

7. A multi-plate type friction engaging apparatus according to claim 1, wherein said bush serves as a lubricating path for lubricating other part.

8. A bush which is used in a multi-plate type friction engaging apparatus for transmitting a power by engagement of plural friction elements housed in a housing and which is interposed between a hub provided on an inner periphery of said housing and a shaft on which said hub is slid, wherein:
a groove extending in an axial direction is formed in an outer peripheral surface or outer and inner peripheral surfaces of said bush.

9. A bush according to claim 8, wherein said groove is cooled by lubricating oil.

10. A bush according to claim 8, wherein a plurality of said grooves are provided in parallel with each other along an axial direction.

11. A bush according to claim 8, wherein said groove is a helical groove.

12. A bush according to claim 8, wherein said groove has a predetermined angle with respect to an axial direction.
